(19) United States
(12) Patent Application Publication
(10) Pub. No.: US 2006/0289792 A1
(43) Pub. Date: Dec. 28, 2006

(54) Cleansing member for opto-electro-mechanical scanning assemblies for photostimulable phosphor imaging plates

(76) Inventor: Edgar Alzner, Garden City, NY (US)

Correspondence Address: CLIFFORD G. FRAYNE, Suite 7A, 136 Drum Point Road, Brick, NJ, 08723, US

(21) Appl. No.: 11/506,045

(22) Filed: Aug. 18, 2006

Related U.S. Application Data
(63) Continuation-in-part of application No. 10/850,545, filed on May 20, 2004.
(60) Provisional application No. 60/472,665, filed on May 23, 2003.

(51) Int. Cl. G01J 1/58

(52) U.S. Cl. 250/485.1

(57) ABSTRACT

These and other objects of the present invention are attained by a cleansing member comprised of a flexible substrate having collection layers formed on one or both sides thereof having an adhesive capability of capturing dust, particulate material and the like, along the transport assembly of an image scanning assemblies. In one embodiment, the cleansing member is dimensioned to conform to intraoral image sized plates. In one embodiment the collection layer is tacky and is provided with a protective layer facily removed prior to use. To facilitate handling of the cleansing member, each collection layer is preferably of a length slightly less than the length of the cleansing member.

### RELATED APPLICATIONS

This application is a continuation-in-part of application Ser. No. 10/850,545, filed May 20, 2004, which application claimed the benefit of provisional application Ser. No. 60/472,665, filed May 23, 2003.

### BACKGROUND OF THE INVENTION

1. Field of the Invention

This invention relates to imaging scanning, and more particularly to a cleansing member for opto-electro-mechanical scanning assemblies for photostimulable phosphor imaging plates.

2. Description of the Prior Art

Traditional x-ray imaging systems using silver-based films are being replaced by radiographic imaging systems using photostimulable phosphor imaging films or storage substrates, thereby eliminating the need for physical storage of the imaged film since digital retrieval of the image information includes input and computer storage permitting viewing of such information on a CRT tube assembly or the equivalent thereof. Additionally, such computer storage imaging information permits facile electronic transmission to any predetermined location obviating the physical transfer of imaged film. Such radiographic imaging further permits the erasure of the image from the photostimulable phosphor imaging film or storage substrate, and the subsequent reuse thereof.

In U.S. Pat. No. 5,874,744 to Goodman, et al., assigned to the same assignee as the present invention, herein incorporated by reference, there is disclosed a process and apparatus for processing radiographic information from an anisotropic storage phosphor screen including an opto-electro-mechanical assembly to achieve faster scan of an interrogating beam and including detector and computer assembly.

In U.S. Pat. No. 6,599,004 to Thoms (incorporated herein by reference), there is disclosed an apparatus for reading flexible storage films wherein the flexible storage film having image-wise projected information is positioned on a cylindrically-shaped surface and is caused to be linearly moved there over by transport assemblies while being interrogated or scanned via a slot by a light beam generated in a helical line in a continuous manner from a point disposed at the axis of the cylindrically-shaped surface.

In copending application Ser. Nos. 60/725,984 and 11/019,078 (incorporated herein by reference), assigned to the same assignee as the present invention, hereby incorporated by reference, there is disclosed a similar apparatus in a vertical orientation for interrogating or scanning an imaged photostimulable phosphor substrate or image substrate.

In U.S. Pat. No. 6,762,430 “Image Plate Guides” (incorporated herein by reference), said application assigned to the Assignee of Applicant there is disclosed image plate guides for image plate scanners which is incorporated by reference and which discussed image plate size.

If the output signal of the photomultiplier is recorded together with the output signals of the position encoders, there is obtained an electric image of the x-ray image previously formed on the storage film in the form of exited metastable color centers of the phosphor particles. Such image is then further processed electrically in view of changing the scale of reproduction, emphasizing details, improving the signal/noise ratio, etc. The resulting x-ray image may be put into an archive in its original and/or digitally processed form requiring very little space.

Digital imaging reading or scanning of an imaging plate is affected by the build-up of dust, particulate matter and the like in the path or track of the transport assembly. Build-up of dust, particulate matter and the like may affect image interrogation and the resulting information to be stored and subsequently viewed during evaluation of such information.

### OBJECTS OF THE INVENTION

An object of the present invention is to provide a cleansing member for opto-electro-mechanical scanning assemblies for photostimuble phosphor imaging plates.

Another object of the present invention is to provide a cleansing member for opto-electro-mechanical scanning assemblies dimensioned to intraoral imaging plates.

Still another object of the present invention is to provide a cleansing member for opto-electro-mechanical scanning assemblies which is facily inserted into transport assemblies of image scanning assemblies.

### SUMMARY OF THE INVENTION

These and other objects of the present invention are attained by a cleansing member comprised of a flexible substrate having a remount adhesive or a velvet-like surface layer formed on either or both sides thereof as more fully hereinafter described having an adhesive capability of capturing dust, particulate material, lint and the like, along the transport assembly of image scanning assemblies. In one embodiment, the cleansing member is dimensioned to conform to the width of an intraoral image sized plate, but longer in length to clean the transport mechanism. Each remount adhesive layer of the cleansing member is provided with a protective layer facily removed prior to use, and each velvet-like surface layer would be individually packaged. To facilitate handling of the cleansing member, each adhesive remount or velvet-like layer is preferably of a length slightly less than the length of the flexible substrate providing edgewise handling of the cleansing member.

### BRIEF DESCRIPTION OF THE DRAWINGS

These and other advantages of the present invention will become more readily apparent from the following detailed description thereof, particularly when taken with the following drawings wherein:

FIG. 1 is a perspective view of an image scanning assembly in a dental configuration;

FIG. 2 is a partial enlarged view of the image scanning assembly of FIG. 1 illustrating the intraoral image plate positioning member;

FIG. 3 is an exploded isometric view of a cleansing member of the present invention;

FIG. 4 is an end view of the cleansing member of the present invention; and

FIG. 5 is an exploded view of a second embodiment of the cleansing member of the present invention.

### DETAILED DESCRIPTION OF THE INVENTION

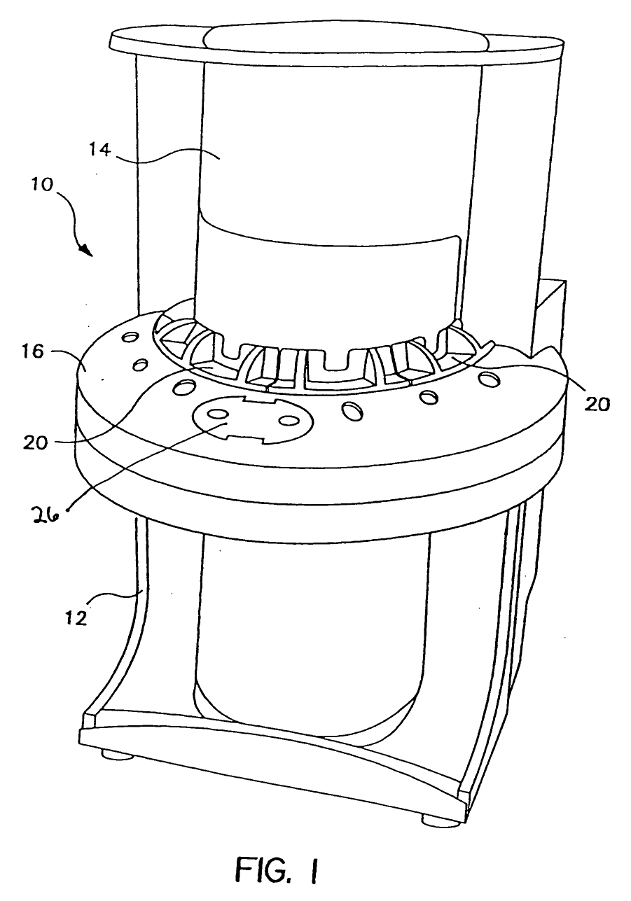

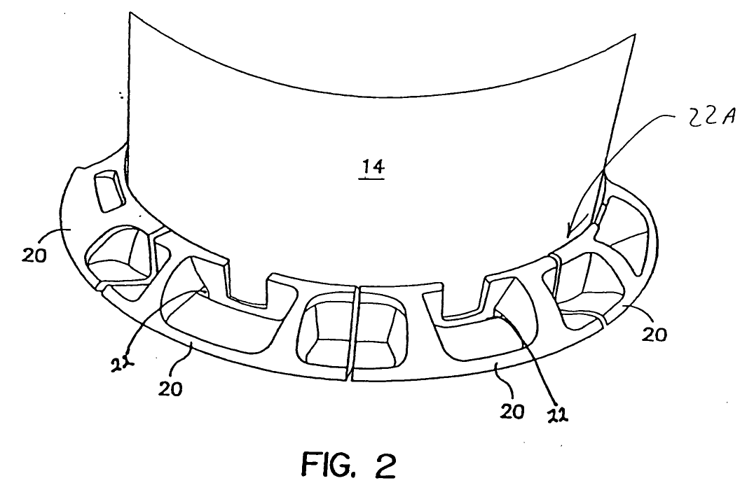

Referring now to FIGS. 1 and 2 there is illustrated an image scanning assembly in a dental configuration, generally indicated as 10, and comprised of a frame 12, an inlet feed cylinder 14, and a transport arch cover 16.

The image scanning assembly 10 is in vertical orientation as compared to the image scanning assembly as hereinabove described with reference to U.S. Pat. No. 6,599,014 to Thoms. The transportation arch cover 16 encloses a transport assembly including a plurality of roller assemblies (not shown). In a dental configuration for scanning intraoral imaging plates, the image scanning assembly 10 is provided with a plurality of image plate positioning members 20 including slots 22 in alignment with roller assemblies of the transport assembly for the insert and transport of intraoral imaging plates (See Applicant's U.S. Pat. No. 6,762,430 “Image Plate Guides”. The slot 22A circumferentially formed about the feed cylinder 14 provides for the insertion and interrogation of what are referred to in the dental arts as panoramic imaging plates. An on/off switch assembly generally indicated as 26 is positioned on the front of the arch cover 16.

Imaging plates are of standardized sizes and are entitled 0,1,2, and 3, size 0 being the smallest. Occlusal imaging plates, size 4 or larger, and panoramic size imaging plates would be larger than occlusal. As a frame of reference, size 0 imaging plates would measure 22×35 mm, size 1 imaging plate would measure 24×40 mm, size 2 imaging plates would measure 31×41 mm, and a size 3 imaging plate would measure 27×54 mm. An occlusal imaging plate would measure 57×76 mm and the panoramic size plate would measure 5″×12″ or 6″×12″ (15 cm×30 cm). The intraoral imaging plates have a thickness of 0.36 mm ±tolerances while the extraoral sizes, such as occlusal and panoramic would have the thickness of 0.64 mm.

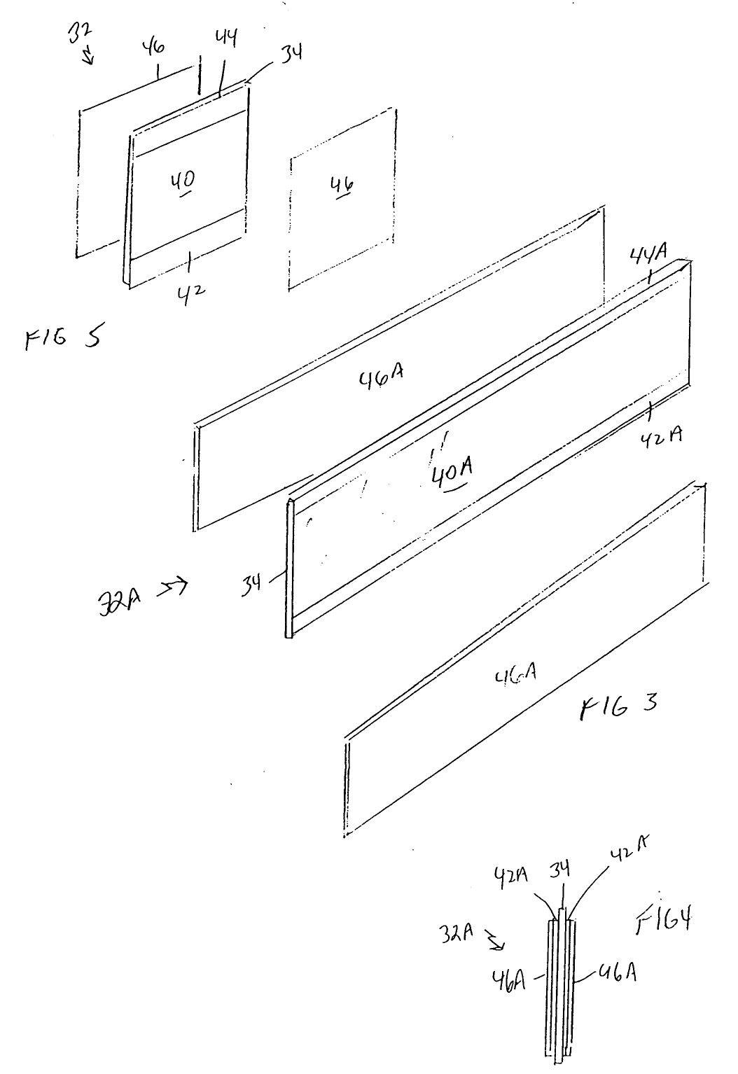

Over the course of time, dust, dirt, lint and like particulate matter materials accumulate within the transport assembly and interfere with scanning and reading of imaging plates. In accordance with the present invention, a cleansing member, generally indicated at 32 or 32A, referring now to FIGS. 3, 4 and 5, is inserted into a slot 22 or 22A and is caused to traverse the transport assembly and clean the transport and scanning areas of the scanner by accumulating such dust, dirt and like particulate matter accumulated therein. It will be understood that the cleansing members 32 and 32A are not drawn to scale and in actual size would approximate the width dimensions of imaging plates size dimensions previously set forth herein.

Cleansing member 32A is representative of what would be referred to as a panoramic cleansing member for the panoramic imaging plate path which commences with slot 22A. The cleansing member 32 illustrated in FIG. 5 is representative of a standard intraoral imaging plate which would be introduced into the transport system by means of slots 22. Cleansing members 32 and 32A perform in this same fashion and the description of their structure and use will be explained with respect to cleansing member 32.

The cleansing member 32 is formed of a flexible substrate 34 of a thickness slightly less than the thickness of an imaging plate. The cleansing member 32 has one or both sides of the flexible substrate 34 coated with a layer or film 40 of a remount adhesive or removable adhesive similar to that of a self-sticking note pad or alternatively a velvet-like material such as flock paper. A width of each remount adhesive or velvet-like layer or film 40 is applied to one or both sides of the substrate in a dimension less than the length of the flexible substrate leaving a margin area 42 and 44 at the upper and lower ends of cleansing member 32. The remount adhesive 40 is covered with a peel off layer 46 to facilitate handling prior to usage, and the alternative velvet-like layer is uncovered except for its delivery container.

In operation, a cleansing member 32 is introduced into the image scanning assembly 10 to follow the path or route of an intraoral imaging plate being scanned by the assembly in order that the cleansing member 32 can collect dust, dirt, debris and like particulate matter. After traversal, the cleansing member 30 is discarded. If the cleansing member is coated only on one side, two such cleansing members are needed to clean both sides of the transport slot or if the cleansing member is not too soiled after the first pass through the transport system, it may be used, but only a second time for cleaning the other side of the transport slot by reversing its entry into the transport slot.

If the cleansing member 32 was introduced into the scanner with the adhesive side facing inwardly, the cleansing member will clean the light seal brushes and the backup rollers of the transport assembly so as to prevent dust, dirt or other particulate matter from affecting the reading and scanning of the photostimulable phosphor imaging plate which might result in image artifacts on the plate not associated with the intraoral image.

If the cleansing member is inserted with the adhesive side facing outwardly, the cleansing member would clean and attract dirt, dust, and lint, and other particulate matter, which may be on the transport belt itself.

While the present invention has been described with reference to dental applications regarding the scanning of intraoral imaging plates, it will be understood by one skilled in the art that the positioning members may be removed and the image scanning assembly used to scan larger imaging plates up to the full width of the feed cylinder 14 and in such configuration, a cleansing member of the type described would be utilized corresponding to the width of the feed cylinder corresponding to the maximum width of the imaging plates being scanned. If the cleansing member is less than the width of the imaging plate guide, the cleansing member could be inserted twice for cleansing, first with a right hand feed and secondly with a left hand feed.

While the present invention has been described with respect to the exemplary embodiments thereof, it will be recognized by those of ordinary skill in the art that many modifications or changes can be achieved without departing from the spirit and scope of the invention. Therefore it is manifestly intended that the invention be limited only by the scope of the claims and the equivalence thereof.

What is claimed is:

1. A cleansing member for insertion into a transport assembly of an image scanning assembly, said image scanning assembly capable of transporting by means of a series of belts and rollers, and scanning by means of laser, dental or medical photo-stimulable phosphor imaging plates having an image thereon resultant from x-ray exposure, said cleansing member comprises a flexible substrate having a collection layer disposed on either side thereof for collection of dirt, dust and particulate matter.

2. The cleansing member for a transport assembly of an image scanning assembly as defined in claim 1 wherein said collection layer comprises a tacky adhesive.

3. The cleansing member for a transport assembly of an image scanning assembly in accordance with claim 1 wherein said collection layer comprises a velvet layer comprising flock paper.

4. The cleansing member for a transport assembly of an image scanning assembly in accordance with claim 1 wherein said cleansing member is opaque.

5. The cleansing member for a transport assembly of an image scanning assembly as defined in claim 2 and further including a protective layer covering said layer of tacky adhesive disposed on either side of said flexible substrate.

6. The cleansing member for a transport assembly of an image scanning assembly as defined in claim 2 wherein a length of said collection layer is less that a length of said flexible substrate.

7. The cleansing member for a transport assembly of an image scanning assembly as defined in claim 1 wherein said flexible substrate is of a thickness less than a thickness of intraoral imaging plate.

8. The cleansing member for a transport assembly of an image scanning assembly as defined in claim 7 wherein a width of said flexible substrate corresponds to a maximum width of an intraoral imaging plate.
